(19) United States
(12) Patent Application Publication
(10) Pub. No.: US 2024/0349124 A1
(43) Pub. Date: Oct. 17, 2024

(54) BASE STATION, TERMINAL, AND COMMUNICATION METHOD

(71) Applicant: Panasonic Intellectual Property Corporation of America, Torrance, CA (US)

(72) Inventors: Tomoya NUNOME, Ishikawa (JP); Hidetoshi SUZUKI, Kanagawa (JP)

(21) Appl. No.: 18/294,437

(22) PCT Filed: May 26, 2022
(86) PCT No.: PCT/JP2022/021593

§ 371 Date: Feb. 1, 2024

(30) Foreign Application Priority Data
Aug. 5, 2021 (JP) 2021-129181

(51) Int. Cl. H04W 28/18; H04W 28/06; H04W 72/0446

(52) U.S. Cl. CPC H04W 28/18; H04W 28/06; H04W 72/0446

(57) ABSTRACT

This base station is equipped with: a control circuit that varies setting of a field of a control signal in accordance with the size of a second field used for terminal allocation, in a first field of the control signal; and a transmission circuit that transmits the control signal on the basis of the setting.

### TECHNICAL FIELD

The present disclosure relates to a base station, a terminal, and a communication method.

### BACKGROUND ART

The specification of a physical layer for Release 16 new radio access technology (NR) has been completed as functional extension of the 5th generation mobile communication systems (5G) in the 3rd generation partnership project (3GPP). NR supports functions for realizing ultra reliable and low latency communication (URLLC) in addition to enhanced mobile broadband (eMBB) to meet a requirement such as high speed and large capacity (see, e.g., Non Patent Literature (hereinafter, referred to as NPL) 1 to NPL 5).

### CITATION LIST

### Non Patent Literature

### NPL 1

3GPP TS 38.211 V16.6.0, “NR; Physical channels and modulation (Release 16),” June 2021

### NPL 2

3GPP TS 38.212 V16.6.0, “NR; Multiplexing and channel coding (Release 16),” June 2021

### NPL 3

3GPP TS 38.213 V16.6.0, “NR; Physical layer procedure for control (Release 16),” June 2021

### NPL 4

3GPP TS 38.214 V16.6.0, “NR; Physical layer procedures for data (Release 16),” June 2021

### NPL 5

3GPP TS 38.331 V16.5.0, “NR; Radio Resource Control (RRC) protocol specification (Release 16),” July 2021

### SUMMARY OF INVENTION

However, there is room for further study on indication of resource allocation in a radio communication.

One non-limiting and exemplary embodiment facilitates providing a base station, a terminal, and a communication method each capable of improving efficiency of indication of resource allocation.

A base station according to an embodiment of the present disclosure includes:
control circuitry, which, in operation, changes a configuration of a field of a control signal depending on a size of a certain field used for assignment for a terminal in a first field of the control signal, the certain field being referred to as a second field; and transmission circuitry, which, in operation, transmits the control signal based on the configuration.

It should be noted that general or specific embodiments may be implemented as a system, an apparatus, a method, an integrated circuit, a computer program, a storage medium, or any selective combination thereof.

According to an exemplary embodiment of the present disclosure, it is possible to improve efficiency of indication of resource allocation.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 illustrates exemplary hybrid automatic repeat request-acknowledgement (HARQ-ACK) transmission for a plurality of physical downlink shared channels (PDSCHs);

FIG. 2 illustrates exemplary scheduling by two PDCCHs;

FIG. 3 illustrates an exemplary time domain resource assignment (TDRA) table;

FIG. 4 is a block diagram illustrating an exemplary configuration of a part of a base station;

FIG. 5 is a block diagram illustrating an exemplary configuration of a part of a terminal;

FIG. 6 is a block diagram illustrating an exemplary configuration of the base station;

FIG. 7 is a block diagram illustrating an exemplary configuration of the terminal;

FIG. 8 is a sequence diagram illustrating exemplary operations of the base station and the terminal;

FIG. 9 illustrates exemplary indication of resource allocation according to Embodiment 1;

FIG. 10 illustrates an exemplary association between indexes and k0 offsets according to Embodiment 1;

FIG. 11 illustrates an exemplary architecture for a 3GPP NR system;

FIG. 12 is a schematic diagram illustrating functional split between a next generation-radio access network (NG-RAN) and 5th generation core (5GC);

FIG. 13 is a sequence diagram for radio resource control (RRC) connection setup/reconfiguration procedures;

FIG. 14 is a schematic diagram illustrating usage scenarios of enhanced mobile broadband (eMBB), massive machine type communications (mMTC), and ultra reliable and low latency communications (URLLC); and

FIG. 15 is a block diagram illustrating an exemplary 5G system architecture for a non-roaming scenario.

### DESCRIPTION OF EMBODIMENTS

Hereinafter, embodiments of the present disclosure will be described in detail with reference to the accompanying drawings.

### [Multiple Physical Downlink Shared Channel (PDSCH) Scheduling]

In Release 17 NR, for example, functional enhancement for realizing communication in frequencies from 52.6 GHz to 71 GHz has been studied.

One of the functional enhancements is to support subcarrier spacing (SCS) such as 480 kHz or 960 kHz higher than the existing SCS. As SCS becomes higher, the time resource lengths such as the symbol and slot lengths are shortened. For example, a slot length is 1 ms for 15 kHz SCS, but 31.25 us for 480 kHz SCS and 15.625 us for 960 kHz SCS.

It may be assumed that, in such a short slot length, a terminal (e.g., also referred to as a user equipment (UE)) does not monitor PDCCH in every slot. This is because, as the slot length (e.g., slot duration) becomes shorter, implementation complexity or power consumption of the terminal possibly increases to complete decoding of a downlink control channel (e.g., physical downlink control channel (PDCCH)) within a shorter period of time at the terminal.

Thus, for example, when a short slot length is configured, it may be assumed that a monitoring period of PDCCH (e.g., PDCCH monitoring occasion) is configured to be longer. Meanwhile, in order to suppress a decrease in a peak rate of throughput, it is expected that a downlink shared channel (or downlink data channel, e.g., physical downlink shared channel (PDSCH)) can be allocated to a resource for each slot individually even when the monitoring period of PDCCH is configured to be longer.

For example, a method for scheduling a plurality of PDSCHs by a single PDCCH (also referred to as “Multiple PDSCH scheduling”) has been studied.

In the Multiple PDSCH scheduling, for example, scheduling of up to eight PDSCHs by one PDCCH has been studied. Note that the number of PDSCHs that can be scheduled by one PDCCH is not limited to eight.

For example, the number of PDSCHs actually scheduled by one PDCCH may be configured using information on time-domain resource allocation (e.g., time domain resource assignment (TDRA) table or PDSCH allocation list. The TDRA table may be, for example, a table (or list) that defines time-domain resource allocation of PDSCH.

For example, a base station (also referred to as “gNB”) configures (or indicates) a content included in the TDRA table to a terminal by higher layer signaling (e.g., Radio Resource Control (RRC) signaling). For example, in the TDRA table, candidates for a combination (e.g., pattern) of parameters related to the time-domain resource may be associated with indexes (e.g., row indexes of the TDRA table). When actually performing resource allocation for a terminal, the base station can indicate time-domain resource allocation of PDSCH by indicating the information on the index of the TDRA table to the terminal by a PDCCH (e.g., downlink control information (DCI)).

The TDRA table may include, for example, time-domain resource allocation patterns in which the number of PDSCHs to be allocated is different. For example, by identifying the content corresponding to the indicated index in the configured TDRA table, the terminal can know the number of PDSCHs to be actually scheduled.

Further, because one PDCCH schedules a plurality of PDSCHs in the Multiple PDSCH scheduling, enhancement of control information indicated by the PDCCH has been studied. For example, it has been studied that at least one of a new data indicator (NDI) and/or a redundancy version (RV) is indicated as many as the number of PDSCHs that can be scheduled by one PDCCH (e.g., the maximum number of PDSCHs). For example, when the maximum number of PDSCHs that can be scheduled by one PDCCH is eight, eight one-bit NDIs and eight one-bit RVs may be indicated by the PDCCH. In this case, the field sizes of NDI and RV are each eight bits.

In this situation, a method for indicating control information in Multiple PDSCH scheduling has not been sufficiently studied. In one non-limiting embodiment of the present disclosure, a method for indicating control information in Multiple PDSCH scheduling will be described. According to one non-limiting embodiment of the present disclosure, for example, it is possible to improve use efficiency of a PDCCH field in Multiple PDSCH scheduling.

### [HARQ-ACK Transmission in Multiple PDSCH Scheduling]

For example, an uplink control channel (e.g., physical uplink control channel (PUCCH)) and an uplink shared channel (or uplink data channel, e.g., physical uplink shared channel (PUSCH)) support a function that collectively transmits response signals (e.g., HARQ-ACKs) for a plurality of PDSCHs. When one PDCCH schedules a plurality of PDSCHs, it may be assumed that HARQ-ACKs for the plurality of PDSCHs are also transmitted by one PUCCH (PUSCH).

However, when HARQ-ACKs for a plurality of PDSCHs are transmitted by one PUCCH (or PUSCH), HARQ-ACK feedback is possibly delayed. This is because, for example, the terminal waits for the last PDSCH reception of the plurality of PDSCHs to transmit HARQ-ACKs for the plurality of PDSCHs by one PUCCH (or PUSCH).

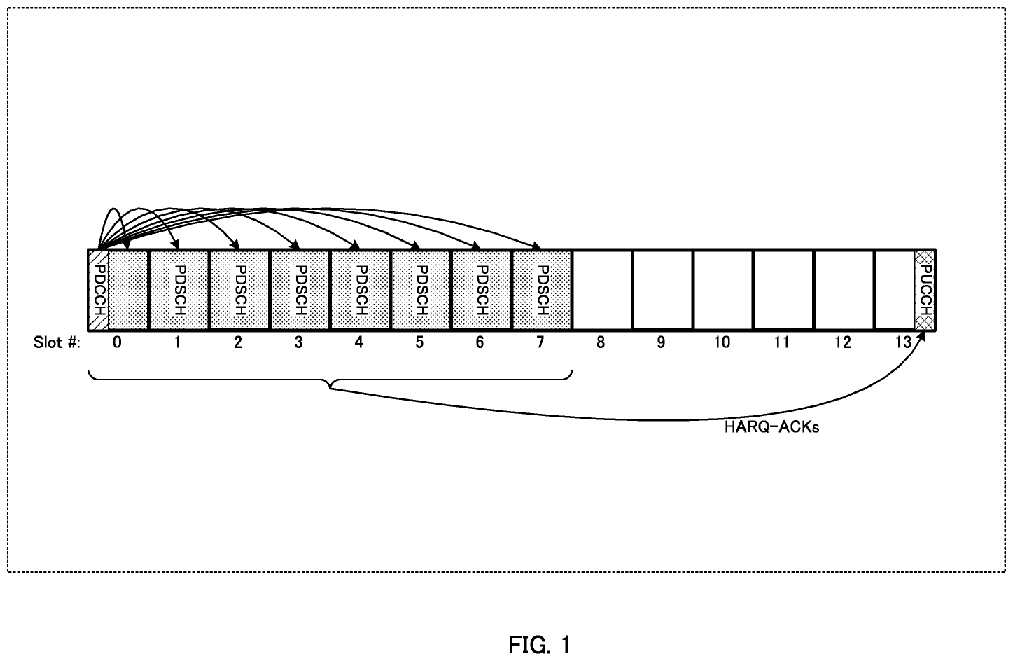

FIG. 1 illustrates exemplary HARQ-ACK transmission for a plurality of PDSCHs. In the example illustrated in FIG. 1, HARQ-ACKs for eight PDSCHs scheduled by one PDCCH are transmitted by one PUCCH. For example, in FIG. 1, after receiving the eight PDSCHs (e.g., slots 0 to 7) indicated by the PDCCH, the terminal may transmit HARQ-ACKs using a PUCCH (or PUSCH) at a predetermined timing (e.g., slot 13).

In the example illustrated in FIG. 1, the terminal performs HARQ-ACK feedback for PDSCHs received respectively in slots 0 to 7, using a PUCCH in slot 13. For example, a HARQ-ACK for a PDSCH in slot 0 (e.g., start of allocated PDSCHs) is transmitted 13 slots after the terminal receives the PDSCH. Further, for example, a HARQ-ACK for a PDSCH in slot 7 (e.g., end of allocated PDSCHs) is transmitted 6 slots after the terminal receives the PDSCH. Thus, for example, compared to the HARQ-ACK feedback for the PDSCH in slot 7, the HARQ-ACK feedback for the PDSCH in slot 0 is delayed for 7 slots.

Such a delay possibly causes starvation of HARQ processes available in the communication system. For example, the base station does not transmit new data unless the HARQ-ACK is fed back from the terminal. In other words, the corresponding HARQ process is released after the HARQ-ACK feedback, and then the base station can transmit new data or retransmission data. Thus, when the available HARQ process is starved due to delays in HARQ-ACK feedback, the base station may be incapable of transmitting new data. When the transmission of new data is limited, a peak rate of throughput possibly decreases.

For example, one way to suppress a decrease in the peak rate of throughput in Multiple PDSCH scheduling is to schedule PDSCHs by dividing the schedule with a plurality of PDCCHs. This method may be applied, for example, when high throughput is required.

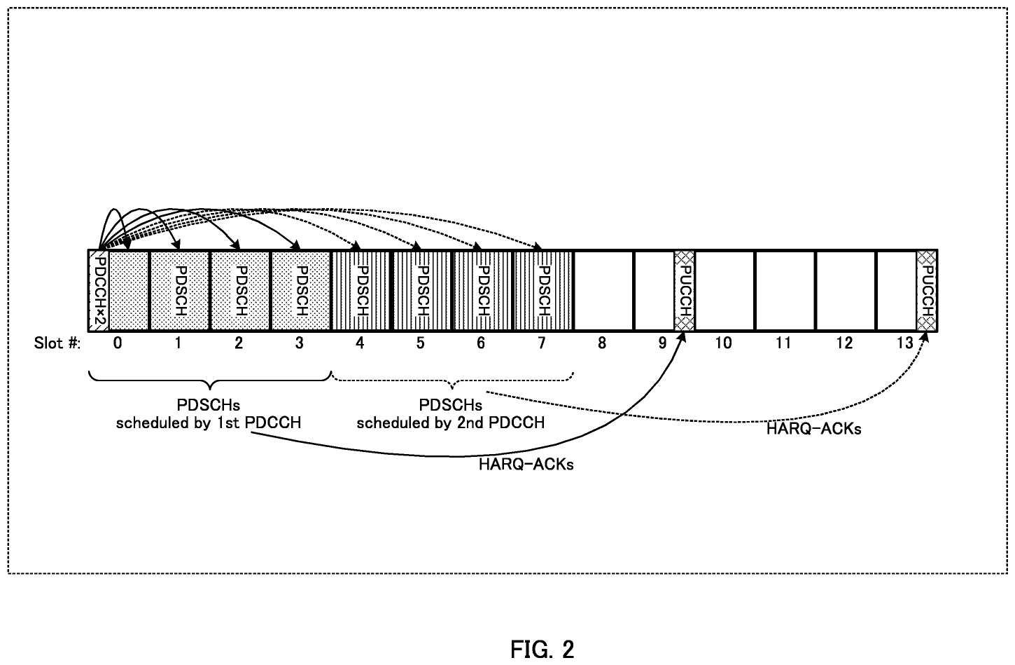

FIG. 2 illustrates exemplary scheduling of eight PDSCHs by two PDCCHs. In the example illustrated in FIG. 2, the base station transmits two PDCCHs (e.g., DCI) in slot 0. In the example illustrated in FIG. 2, the first PDCCH schedules the first half of PDSCHs (slots 0 to 3), and the second PDCCH schedules the second half of PDSCHs (slots 4 to 7). Further, as illustrated in FIG. 2, HARQ-ACK transmissions by different PUCCHs (e.g., PUCCHs in slots 9 and 13) may be configured for the first half of PDSCHs and the second half of PDSCHs.

Thus, the number of slots from a PDSCH reception in slot 0 to a HARQ-ACK transmission for the PDSCH at the terminal is nine slots in FIG. 2, while 13 slots in FIG. 1, and thus a feedback delay can be improved. Accordingly, dividing the schedule with a plurality of PDCCHs in Multiple PDSCH scheduling can improve a feedback delay and throughput.

For example, when scheduling of a plurality of PDSCHs is performed by dividing the schedule with a plurality of PDCCHs, use efficiency of a PDCCH field possibly decreases.

For example, when scheduling of a plurality of PDSCHs is performed by dividing the schedule with two PDCCHs, k0 (e.g., slot difference between a PDCCH and a PDSCH) is possibly different between the two PDCCHs even though time-domain resource allocation for the plurality of PDSCHs (e.g., a plurality of slots) is the same (e.g., allocation in which a Start and Length Indicator Value (SLIV) is the same). For this reason, it may be assumed to configure (register) patterns of time-domain resource allocation with different indexes in the TDRA table in order to allow the time-domain resource allocation by each of the two PDCCHs.

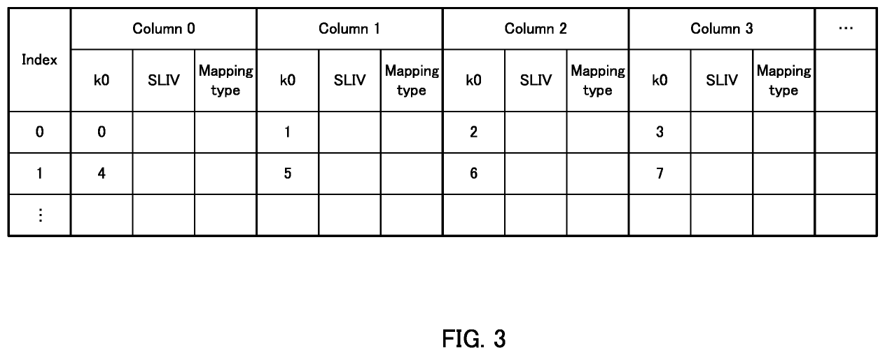

FIG. 3 illustrates an exemplary TDRA table. For example, the TDRA table illustrated in FIG. 3 may include columns corresponding to respective configurations of time-domain resource allocation for a plurality of PDSCHs (e.g., the number of PDSCHs that can be assigned by one PDCCH) in each index. Note that configurations of column 4 and more are omitted in FIG. 3.

Further, parameters on the time-domain resource allocation may include k0, SLIV, and Mapping type, and may include another parameter. Furthermore, a parameter that is not commonly included in each of the plurality of columns may be included. For example, one k0 may be included in one index. For example, k0 for Column 0 may be included, and after Column 1, the value of k0 in each Column may be implicitly indicated by incrementing the indicated value of K0 by one. Note that, in the TDRA table illustrated in FIG. 3, values of parameters different from k0 (e.g., SLIV and Mapping type) are omitted.

For example, in the TDRA table illustrated in FIG. 3, time-domain resource allocation for four PDSCHs (columns 0 to 3) may be configured in index 0 and index 1. In this case, between indexes 0 and 1 illustrated in FIG. 3, for example, the configuration of SLIV may be the same and the configuration of k0 may be different. For example, when resource allocation illustrated in FIG. 2 is performed, index 0 may be used for the first PDCCH (scheduling PDSCHs in slots 0 to 3), and index 1 may be used for the second PDCCH (scheduling PDSCHs in slots 4 to 7).

When the scheduling is performed by dividing the schedule with a plurality of PDCCHs in the Multiple PDSCH scheduling, a configuration with a plurality of patterns between which the value of k0 is different in the TDRA table is possibly used. For example, because the number of indexes configurable in the TDRA table (the number of bits available for indication of the index) is limited, configuring different patterns only for k0 in the TDRA table increases redundancy and possibly decreases flexibility of time-domain resource allocation.

Further, as described above, respective fields (e.g., bit fields) of NDI and RV in a PDCCH (e.g., DCI) are configured based on, for example, the maximum number of PDSCHs in the Multiple PDSCH scheduling. Thus, when the Multiple PDSCH scheduling is performed by dividing the schedule with a plurality of PDCCHs, a field (e.g., the number of bits) corresponding to the maximum number of PDSCHs is reserved for each of NDI and RV in each PDCCH. For example, when the maximum number of PDSCHs that can be scheduled by one PDCCH is eight and the number of PDSCHs actually scheduled by one PDCCH is four, four bits are used for indication of each of NDI and RV in the PDCCH, and each remaining four-bit is not used. The bits used for indication of NDI and RV may not be effectively used.

One non-limiting embodiment of the present disclosure describes a method for improving the use efficiency of bits used for indication of parameters such as NDI and RV, for example. Further, one non-limiting embodiment of the present disclosure describes a method for improving the flexibility of time-domain resource allocation in Multiple PDSCH scheduling, for example.

### Embodiment 1

### [Overview of Communication System]

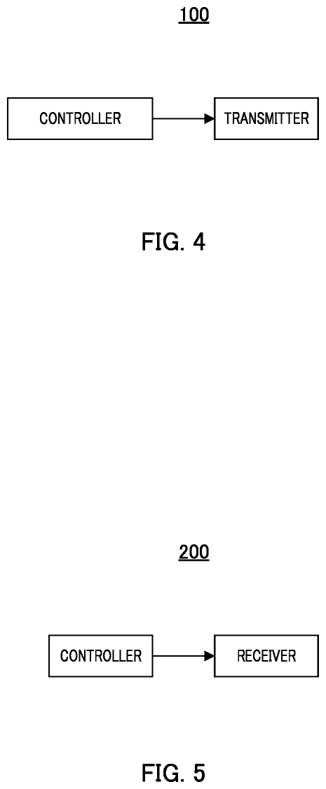

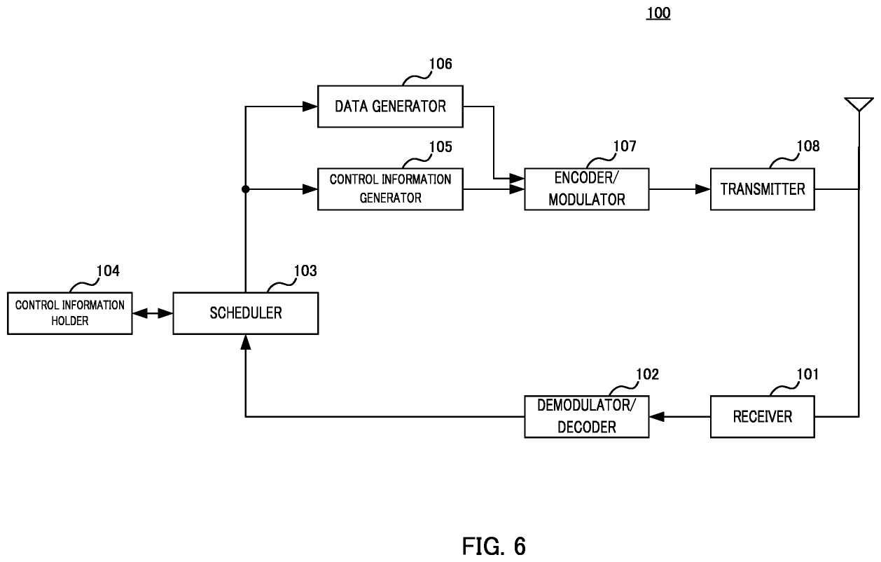

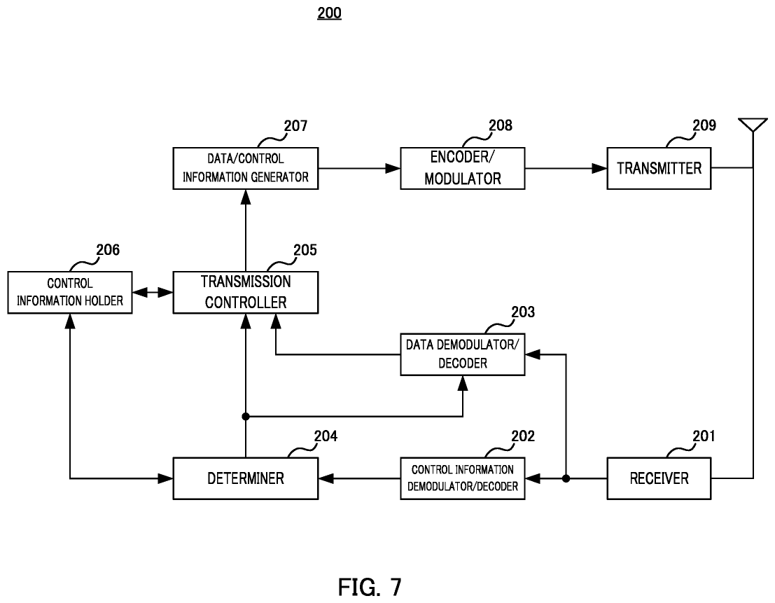

A communication system according to an aspect of the present disclosure may include, for example, base station 100 (e.g., gNB) illustrated in FIGS. 4 and 6 and terminal 200 (e.g., UE) illustrated in FIGS. 5 and 7. The communication system may include a plurality of base stations 100 and a plurality of terminals 200.

FIG. 4 is a block diagram illustrating an exemplary configuration of a part of base station 100 according to an aspect of the present disclosure. In base station 100 illustrated in FIG. 4, a controller (e.g., corresponding to control circuitry) changes a configuration of a field of a control signal (PDCCH or DCI) depending on a size of the second field used for allocation for a terminal in the first field of the control signal. A transmitter (e.g., corresponding to transmission circuitry) transmits the control signal based on the configuration.

FIG. 5 is a block diagram illustrating an exemplary configuration of a part of terminal 200 according to an aspect of the present disclosure. In terminal 200 illustrated in FIG. 5, a controller (e.g., corresponding to control circuitry) changes a configuration of a field of a control signal (PDCCH or DCI) depending on a size of the second field used for allocation for a terminal in the first field of the control signal. A receiver (e.g., corresponding to reception circuitry) receives the control signal based on the configuration.

### [Configuration of Base Station]

FIG. 6 is a block diagram illustrating an exemplary configuration of base station 100 according to an aspect of the present disclosure. In FIG. 6, base station 100 includes receiver 101, demodulator/decoder 102, scheduler 103, control information holder 104, control information generator 105, data generator 106, encoder/modulator 107, and transmitter 108.

Note that, for example, at least one of demodulator/decoder 102, scheduler 103, control information holder 104, control information generator 105, data generator 106, and encoder/modulator 107 may be included in the controller illustrated in FIG. 4, and transmitter 108 may be included in the transmitter illustrated in FIG. 4.

For example, receiver 101 performs reception processing such as down-conversion or A/D conversion on the received signal received via the antenna, and outputs the received signal after the reception processing to demodulator/decoder 102.

For example, demodulator/decoder 102 demodulates and decodes the received signal (e.g., uplink signal) inputted from receiver 101 and outputs the decoding result to scheduler 103.

Scheduler 103 may perform scheduling for terminal 200, for example. For example, scheduler 103 may determine information on Multiple PDSCH scheduling. For example, scheduler 103 indicates generation of control information to control information generator 105 based on at least one of the decoding result inputted from demodulator/decoder 102 and/or control information inputted from the control information holder. The information on the indication of generation of control information may include, for example, information on the number of PDSCHs scheduled for terminal 200 or the maximum number of PDSCHs. Further, scheduler 103, for example, indicates data generation to data generator 106 based on at least one of the decoding result inputted from demodulator/decoder 102 and/or control information inputted from control information holder 104. The information on the indication of data generation may include, for example, signaling information (e.g., information on a TDRA table). Furthermore, scheduler 103 may output control information on scheduling for terminal 200 to control information holder 104.

Control information holder 104 holds, for example, control information (e.g., information on a TDRA table) configured in each terminal 200. For example, control information holder 104 may output the held information to each component (e.g., scheduler 103) of base station 100 as needed.

For example, control information generator 105 generates control information in accordance with the indication from scheduler 103 and outputs the generated control information to encoder/modulator 107. For example, control information generator 105 may generate downlink control information based on the maximum number of PDSCHs in Multiple PDSCH scheduling and the number of PDSCHs scheduled for terminal 200.

For example, data generator 106 generates data in accordance with the indication from scheduler 103 and outputs the generated data to encoder/modulator 107. For example, data generator 106 may generate data including signaling information based on the indication of generation of signaling information inputted from scheduler 103.

Encoder/modulator 107 encodes and modulates the signals inputted from control information generator 105 and data generator 106, and outputs the modulated signal to transmitter 108.

Transmitter 108 performs transmission processing such as D/A conversion, up-conversion, or amplification on the signal inputted from encoder/modulator 107, for example, and transmits a radio signal obtained by the transmission processing through the antenna to terminal 200.

### [Configuration of Terminal]

FIG. 7 is a block diagram illustrating an exemplary configuration of terminal 200 according to an aspect of the present disclosure. In FIG. 7, terminal 200 includes receiver 201, control information demodulator/decoder 202, data demodulator/decoder 203, determiner 204, transmission controller 205, control information holder 206, data/control information generator 207, encoder/modulator 208, and transmitter 209.

Note that, for example, at least one of control information demodulator/decoder 202, data demodulator/decoder 203, determiner 204, transmission controller 205, control information holder 206, data/control information generator 207, and encoder/modulator 208 may be included in the controller illustrated in FIG. 4, and receiver 201 may be included in the receiver illustrated in FIG. 5.

For example, receiver 201 performs reception processing such as down-conversion or A/D conversion on the received signal received through the antenna, and outputs the received signal after the reception processing to control information demodulator/decoder 202 and data demodulator/decoder 203.

For example, control information demodulator/decoder 202 demodulates and decodes the received signal inputted from receiver 201 and outputs a decoding result of control information to determiner 204. The decoding result of control information may include, for example, downlink control information.

For example, data demodulator/decoder 203 demodulates and decode the received signal inputted from receiver 201 based on the downlink information inputted from determiner 204 and outputs a decoding result of data to transmission controller 205. The decoding result of data may include, for example, signaling information (e.g., information on a TDRA table).

Determiner 204 determines downlink control information from the decoding result of control information inputted from control information demodulator/decoder 202 based on control information (e.g., information on a TDRA table) inputted from control information holder 206. For example, determiner 204 may determine a content included in the downlink control information (e.g., field configuration in control information) from a bit sequence after the decoding of control information. Determiner 204 outputs the determined downlink control information to data demodulator/decoder 203, transmission controller 205, and control information holder 206.

For example, transmission controller 205 outputs the signaling information (e.g., information on a TDRA table) included in the decoding result inputted from data demodulator/decoder 203 to control information holder 206. Further, transmission controller 205 may indicate generation of data or control information to data/control information generator 207 based on the control information inputted from control information holder 206, the downlink control information inputted from determiner 204, or the decoding result of data inputted from data demodulator/decoder 203.

Control information holder 206 holds control information such as the signaling information inputted from transmission controller 205 (e.g., information on a TDRA table) or the downlink control information inputted from determiner 204, and outputs the held information to each component (e.g., transmission controller 205) as needed.

For example, data/control information generator 207 generates data or control information in accordance with the indication from transmission controller 205 and outputs a signal including the generated data or control information to encoder/modulator 208.

Encoder/modulator 208 encodes and modulates the signal inputted from data/control information generator 207 and outputs the modulated transmission signal to transmitter 209.

Transmitter 209 performs transmission processing such as D/A conversion, up-conversion, or amplification on the signal inputted from encoder/modulator 208, for example, and transmits a radio signal obtained by the transmission processing through the antenna to base station 100.

### [Operations of Base Station 100 and Terminal 200]

Exemplary operations in base station 100 and terminal 200 having the above configuration will be described.

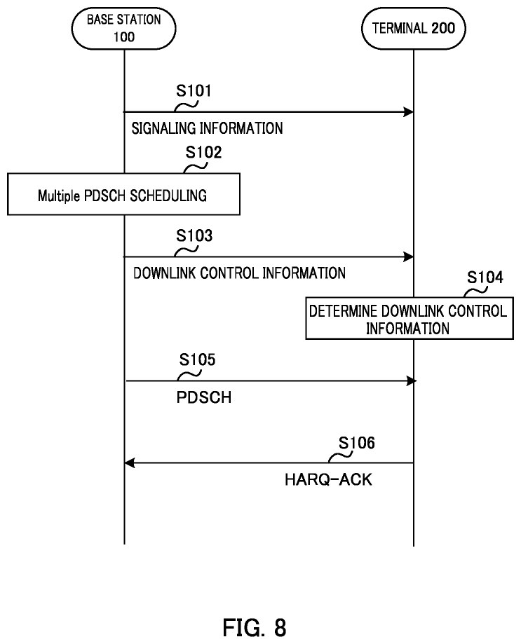

FIG. 8 is a sequence diagram illustrating exemplary operations of base station 100 and terminal 200.

Base station 100 may transmit signaling information to terminal 200 (S101). The signaling information may include, for example, information on a configuration of Multiple PDSCH scheduling such as a configuration of a TDRA table.

Base station 100 may perform Multiple PDSCH scheduling for terminal 200, for example (S102). For example, base station 100 may determine the number of PDSCHs (e.g., the number of slots) to be assigned for terminal 200 in the Multiple PDSCH scheduling. Further, for example, base station 100 may determine the number of PDCCHs (e.g., DCI) for indicating the PDSCHs to be assigned for the terminal.

Base station 100 may transmit downlink control information to terminal 200 based on the scheduling result (S103).

Terminal 200 may determine the downlink control information based on, for example, signaling information (e.g., TDRA table) (S104). For example, terminal 200 may identify the content of the downlink control information (e.g., field configuration of control information) based on the maximum number of PDSCHs configurable for terminal 200 and the number of PDSCHs assigned for terminal 200, and identify time-domain resource allocation of the PDSCHs.

Base station 100 may transmit the PDSCHs to terminal 200, for example (S105). Terminal 200 may receive the PDSCHs based on the identified time-domain resources, for example.

Terminal 200 may transmit HARQ-ACKs for the PDSCHs to base station 100 (S106).

### [Method for Switching Control Data (k0 Offset Indicator)]

Hereinafter, a method for switching control information at base station 100 (e.g., control information generator 105) will be described. Note that terminal 200 (e.g., determiner 204) may determine control information with the assumption that base station 100 switches the control information.

In the present embodiment, base station 100 switches the presence or absence of a “k0 offset indicator” field in a PDCCH.

The k0 offset indicator may be, for example, information on an offset for a difference (e.g., k0) between a slot in which a PDCCH is mapped and a slot in which a PDSCH allocated by the PDCCH is mapped.

Base station 100 may, for example, switch the presence or absence of the configuration of a k0 offset indicator field based on the number of PDSCHs scheduled for terminal 200 by one PDCCH and the maximum number of PDSCHs that can be scheduled by one PDCCH. For example, when the number of PDSCHs scheduled for terminal 200 by one PDCCH is smaller than the maximum number of PDSCHs or smaller than a set threshold value (or both conditions are satisfied), base station 100 may determine the configuration of a k0 offset indicator field in the PDCCH (in other words, may enable the configuration). When the number of PDSCHs scheduled by one PDCCH is, on the other hand, equal to the maximum number of PDSCHs or equal to or larger than the set threshold value, for example, base station 100 may determine the non-configuration of the k0 offset indicator field in the PDCCH (in other words, may disable the configuration).

For example, base station 100 may configure (or use) an area (bit) not used in at least one of an NDI field and/or an RV field in the PDCCH as the k0 offset indicator field. For example, for the NDI and RV, the numbers of bits of the fields are determined depending on the maximum number of PDSCHs. Meanwhile, in the NDI and RV fields, the number of bits actually used are the same as the number of scheduled PDSCHs, and the remaining bits are not used. Taking advantage of it, when the number of scheduled PDSCHs is smaller than the maximum number of PDSCHs (or threshold value), base station 100 may indicate a k0 offset indicator using a bit not used for at least one of NDI and/or RV, for example.

That is, base station 100 may configure the k0 offset indicator field in a field (in other words, field not used by NDI or RV) different from the field corresponding to the number used for allocation for terminal 200 (in other words, field used by NDI or RV) in a field corresponding to the maximum number of PDSCHs for at least one of NDI and/or RV in a PDCCH.

As described above, for example, base station 100 and terminal 200 may replace at least a part of the field of NDI and/or RV with the k0 offset indicator field. In other words, base station 100 and terminal 200 may change the configuration of at least one of NDI and/or RV fields depending on the number of PDSCHs scheduled for terminal 200 (or the size of the used field in the NDI and RV fields). It should be noted that the term “configuration” of a field in a PDCCH (or DCI) may be replaced with another term such as “definition,” “interpretation,” or the like.

For example, when the maximum number of PDSCHs that can be scheduled by one PDCCH is eight and the number of PDSCHs used for scheduling for terminal 200 is four, four bits are used to indicate each of NDI or RV, and the remaining four bits are not used to indicate each of NDI and RV. In this case, base station 100 may indicate a k0 offset indicator using the unused four bits of at least one of NDI and/or RV. Similarly, when the number of PDSCHs scheduled by a PDCCH is four, terminal 200 may perform reception processing, assuming that the k0 offset indicator is indicated in the unused four bits of at least one of NDI and/or RV, for example.

This allows indication of k0 offset indicator without increasing the number of bits of PDCCH.

Note that the field used for the indication of k0 offset indicator is not limited to the fields of NDI and RV, and may be another field.

An exemplary method for applying a k0 offset indicator will be described below.

### <Method 1>

In Method 1, a k0 offset indicator may indicate whether a k0 offset to be applied.

A value of k0 offset may be configured in terminal 200 by at least one of higher layer signaling and/or downlink control information, or may be predefined in the standard.

For example, when a value of k0 offset indicator is 0, a k0 offset may be applied, and when the value of k0 offset indicator is 1, no k0 offset may be applied.

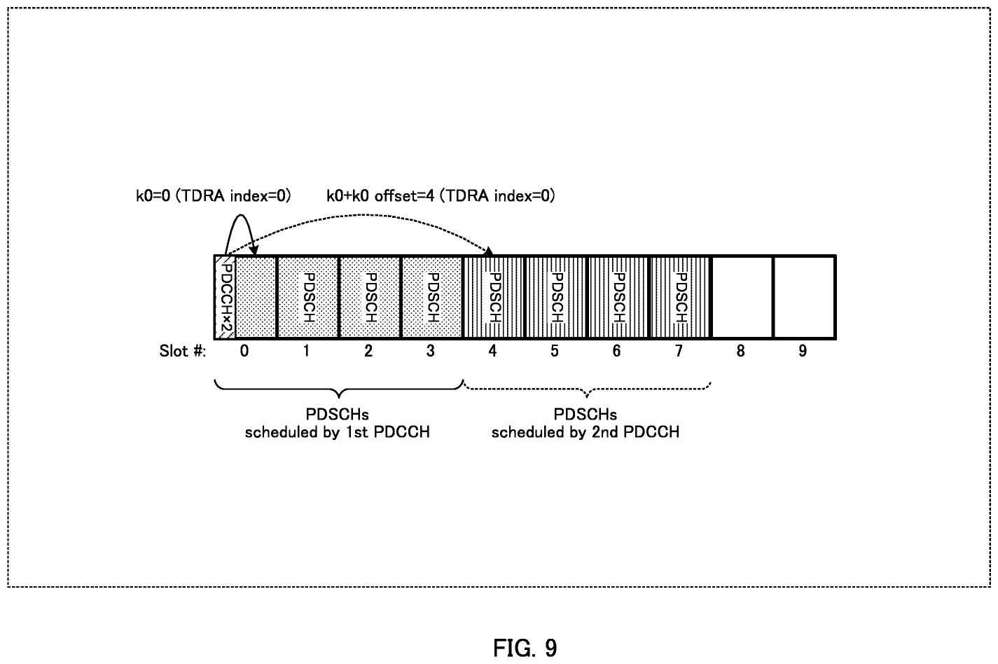

FIG. 9 illustrates an example in which a k0 offset indicator is applied. In the example illustrated in FIG. 9, similarly to the example in FIG. 2, eight PDSCHs are scheduled for terminal 200 by two PDCCHs. Further, in FIG. 9, for example, the maximum number of PDSCHs that can be scheduled by each of the PDCCHs is eight. Note that some of the arrows indicating scheduling of PDSCHs by a PDCCH are omitted in FIG. 9.

Further, in the example illustrated in FIG. 9, a k0 offset value is set to 4 (slots). Further, in the example illustrated in FIG. 9, the TDRA table illustrated in FIG. 3 is configured for terminal 200.

As illustrated in FIG. 9, the same time-domain resource (e.g., SLIV) may be allocated for the first half of PDSCHs (slots 0 to 3) and the second half of PDSCHs (slots 4 to 7) of the eight PDSCHs. In this case, base station 100 may configure index 0 (TDRA index=0) of the TDRA table in both of the respective PDCCHs (or DCI) allocating the first half of PDSCHs and the second half of PDSCHs.

Further, for example, because the number of PDSCHs=4 assigned for terminal 200 is smaller than the maximum number of PDSCHs-8 in each of the two PDCCHs, base station 100 may configure a k0 offset indicator field in each of the PDCCH fields. For example, base station 100 may configure a k0 offset indicator field in an NDI or RV field corresponding to the four PDSCHs not used in each of the PDCCHs.

For example, base station 100 may indicate k0 offset indicator-0 (e.g., non-application of k0 offset) by the PDCCH scheduling the first half of PDSCHs and indicate k0 offset indicator=1 (e.g., application of k0 offset) by the PDCCH scheduling the second half of PDSCHs. Then, the k0 offset is applied to the second half of PDSCHs.

For example, because the value of k0 for a PDSCH in slot 0 is 0 in index 0 of the TDRA table as illustrated in FIG. 3 and the k0 offset is not applied, terminal 200 determines that the time resource allocated for the first PDSCH of the first half of PDSCHs scheduled for terminal 200 is slot 0 (the same slot as PDCCH) as illustrated in FIG. 9. For other first-half PDSCHs scheduled for terminal 200, the time resources (slots) may be similarly identified.

Further, because the value of k0 for a PDSCH in slot 4 is 0 in index 0 of the TDRA table as illustrated in FIG. 3 and the k0 offset is applied, the actual k0 value is set to 0+4=4. Thus, for example, as illustrated in FIG. 9, terminal 200 determines that the time resource allocated for the first PDSCH of the second half of PDSCHs (the fifth PDSCH as a whole) scheduled for terminal 200 is slot 4 (4 slots after PDCCH). For other second-half PDSCHs scheduled for terminal 200, the time resources (slots) may be similarly identified.

As described above, by the k0 offset indicator, the PDCCH scheduling the first half of PDSCHs and the PDCCH scheduling the second half of the PDSCHs can use the same index of the TDRA table. In other words, different PDSCH scheduling using the same index of the TDRA table is possible.

For example, in the PDSCH allocation example illustrated in FIG. 2, index 1 of the TDRA table is used for the second half of PDSCHs, whereas, in the PDSCH allocation example according to Method 1 illustrated in FIG. 9, index 1 need not be used for the second half of PDSCHs. In other words, for the second half of PDSCHs, an index different from that for the first half of PDSCHs is used in the example illustrated in FIG. 2, whereas the same index 0 as for the first half of PDSCHs may be used in Method 1.

As described above, different k0 can be set by a k0 offset indicator according to Method 1, and thus, patterns in which only k0 is different and other parameter values are the same need not be configured in the configuration (e.g., TDRA table) of the time-domain resource. For example, in the time-domain resource configuration, patterns in which value of a plurality of parameters including k0 are different may be configured (registered) in the TDRA table. This can decrease the number of bits (the number of indexes) used in the TDRA table in Multiple PDSCH scheduling, for example. Alternatively, even when the number of bits used in the TDRA table is the same, patterns of time-domain resource allocation can be increased and the flexibility of time-domain resource allocation can be enhanced compared to the example illustrated in FIG. 2.

### <Method 2>

In Method 2, a k0 offset indicator may indicate a k0 offset value.

For example, the k0 offset indicator may indicate any one of indexes associated with a plurality of preconfigured k0 offsets (candidates). A plurality of candidates for the k0 offset may be, for example, configured in terminal 200 by at least one of higher layer signaling and/or downlink control information, or may be predefined in the standard. Further, the information on an association between the plurality of k0 offsets and indexes may be information in a table format or information in another format, for example.

Note that the k0 offset value may be set to 0 (no offset). For example, when the number of k0 offsets (the number registered in the table) is N, the number of bits of the k0 offset indicator may be set to ceil (log₂ N).

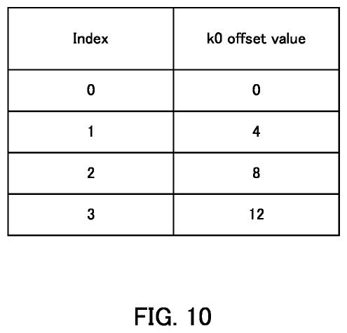

FIG. 10 illustrates an exemplary k0 offset table indicating an association between k0 offset values and indexes. In the example illustrated in FIG. 10, the number (N) of k0 offsets is four, and the number of bits of the k0 offset is two bits. Base station 100 may, for example, indicate a k0 offset value corresponding to any of indexes 0 to 3 to terminal 200 by a k0 offset indicator (e.g., two bits).

As described above, in Method 2, reusability of TDRA table can be enhanced by allowing indication of a plurality of k0 offset values. In other words, different k0 can be applied to the same index of the TDRA table. This can decrease the number of bits (the number of indexes) used in the TDRA table in Multiple PDSCH scheduling, for example. Alternatively, even when the number of bits used in the TDRA table is the same, the patterns of time-domain resource allocation can be increased and the flexibility of time-domain resource allocation can be enhanced compared to the example illustrated in FIG. 2.

Note that a plurality of types of k0 offset tables may be defined. For example, a plurality of types of k0 offset tables may be preconfigured in terminal 200 by higher layer signaling, and a k0 offset table to be applied to terminal 200 may be switched depending on the condition. The condition of switching the k0 offset table may be, for example, the number of scheduled PDSCHs or the number of bits available for the k0 offset indicator (e.g., the number of bits not used in the NDI and RV fields).

Such a selective use of a plurality of k0 offset tables can further reduce the number of bits required for the TDRA table. Alternatively, even when the number of bits used in the TDRA table is the same, patterns of time-domain resource allocation can be increased and the flexibility of time-domain resource allocation can be enhanced compared to the example illustrated in FIG. 2.

Note that some of set k0 offset values (or range) may be different, or the number of bits (the number of indexes or candidates) may be different between the plurality of k0 offset tables

Methods 1 and 2 according to the present embodiment have been described above.

As described above, in the present embodiment, base station 100 and terminal 200 may change a configuration of a PDCCH (or DCI) field based on the number of a plurality of PDSCHs that can be scheduled by one PDCCH (or DCI) and the number of PDSCHs assigned for terminal 200 among the plurality of PDSCHs. For example, base station 100 and terminal 200 may switch the presence or absence of a configuration of k0 offset indicator depending on the size of the field (e.g., field to be used) that is based on the number of PDSCHs assigned for terminal 200 in the NDI or RV field configured based on the number of the plurality of PDSCHs that can be scheduled by the PDCCH.

Thus, for example, when the maximum number of PDSCHs in Multiple PDSCH scheduling is not assigned for terminal 200, an unused field of the NDI and RV fields reserved in the Multiple PDSCH scheduling can be used by being read as a k0 offset indicator field. Accordingly, the bits used for indication of the NDI and RV can be effectively used, which improves the use efficiency of control information.

Further, when PDSCHs are scheduled by dividing the schedule with a plurality of PDCCHs in Multi PDSCH scheduling, a configuration of different k0 is possible by reading at least one of NDI and/or RV fields as a k0 offset indicator, without configuring a plurality of patterns between which k0 is different and other parameters are the same in the TDRA table. Thus, for example, redundant configuration in the TDRA table can be avoided and the flexibility of time-domain resource allocation can be enhanced even when the number of indexes (e.g., the number of bits available for indication of index) configurable in the TDRA table is limited.

Therefore, according to the present embodiment, the efficiency of indication of resource allocation can be enhanced.

Note that the methods of switching control information described in the present embodiment are not limited to be applied to Multiple PDSCH scheduling. For example, the above-described methods may be applied to a case where PDSCHs are not scheduled by dividing the schedule with a plurality of PDCCHs or where Multiple PDSCH scheduling is not applied.

For example, when the monitoring period of PDCCH is long (or when the monitoring frequency of PDCCH is low), in such a case where relatively high SCS is applied, a difference between a slot in which a PDCCH is received and a slot of a PDSCH scheduled by the PDCCH is likely to be large. Thus, it is expected to register, in the TDRA table, patterns between which time-domain resource allocation (SLIV) is the same but k0 is different. Applying the method described in the present embodiment in such a case can increase the pattern of k0 using the k0 offset and decrease the number of bits used for the TDRA table. Alternatively, even when the number of bits used in the TDRA table is the same, patterns of time-domain resource allocation can be increased and the flexibility of time-domain resource allocation can be enhanced compared to the example illustrated in FIG. 2.

Further, the methods according to the present embodiment may be applied to, for example, a case where one PDSCH is scheduled by one PDCCH (in other words, a case where the maximum number of PDSCHs is one). Because the NDI and RV fields are not reserved for a plurality of PDSCHs when the maximum number of PDSCHs is one, a bit of a field that may be unused among fields different from the NDI and RV may be used for the k0 offset indicator, for example.

For example, when, among a plurality (e.g., two) of transport blocks (TBs) in one PDSCH scheduled by a PDCCH (or DCI), one or some TBs (e.g., one) (e.g., may be referred to as the 1st TB) is used, base station 100 may configure a field of at least one of modulation and coding scheme (MCS), NDI, and/or RV corresponding to the remaining TB (e.g., may be referred to as the 2nd TB) as a k0 offset indicator field.

### Embodiment 2

In an exemplary configuration of the base station and the terminal according to the present embodiment, for example, some functions may be different from those in Embodiment 1 and the other functions may be the same as those in Embodiment 1.

In the present embodiment, a method for switching control information is different from that in Embodiment 1.

For example, in the present embodiment, base station 100 switches the number of bits (size) of an RV field corresponding to each of PDSCHs assigned by a PDCCH.

For example, base station 100 may change a configuration of a field (e.g., at least one of NDI and/or RV fields) in a PDCCH depending on the number of PDSCHs scheduled by the PDCCH. Terminal 200 may perform reception processing, similarly assuming that the configuration of the field in the PDCCH is changed depending on the number of PDSCHs scheduled by the PDCCH.

### <Method 1>

In Method 1, when the number of PDSCHs scheduled by one PDCCH is smaller than a set threshold value, base station 100 may set the number of bits of the RV field of the PDCCH to two bits, and when the number of PDSCHs scheduled by one PDCCH is equal to or larger than the set threshold value, base station 100 may set the number of bits of an RV field of the PDCCH to one bit.

For example, when the number of PDSCHs scheduled by one PDCCH is equal to or smaller than half the maximum number of PDSCHs, base station 100 may set the number of bits of the RV field of the PDCCH to two bit, and when the number of PDSCHs scheduled by one PDCCH is larger than half the maximum number of PDSCHs, base station 100 may set the number of bits of the RV field of the PDCCH to one bit. In other words, when the number of PDSCHs scheduled by one PDCCH is equal to or smaller than a threshold value (e.g., may be half the maximum number of PDSCHs), base station 100 may set the number of bits of the RV corresponding to each of scheduled PDSCHs to the first number of bits, and when the number of scheduled PDSCHs is larger than the threshold value, base station 100 may set the number of bits of the RV corresponding to each of scheduled PDSCHs to the second number of bits, which is smaller than the first number of bits.

Note that the number of bits of the RV field may be set to two bits when the condition regarding the maximum number of PDSCHs with respect to the number of PDSCHs scheduled by one PDCCH and the condition regarding the threshold value described above are both satisfied.

For example, when the maximum number of PDSCHs that can be scheduled by one PDCCH is eight and the number of PDSCHs actually used for scheduling for terminal 200 is four, base station 100 may set the number of bits of the RV field corresponding to each of the four PDSCHs in the PDCCH to two bits. In this case, the sum of the number of bits of the RV in the PDCCH is 4 RVs×2 bits=8 bits. That is, the number of bits (8 bits) reserved for the RV field in the PDCCH can be fully used by increasing the number of bits of the RV for each of the four PDSCHs.

Alternatively, base station 100 may determine the number of bits of the RV, taking into consideration of an unused field (bit) of an NDI field (or a field different from the NDI), for example. For example, when the number of PDSCHs scheduled by one PDCCH is equal to or smaller than a threshold value, base station 100 may set the number of bits of the RV to two bit, and when the number of PDSCHs scheduled by one PDCCH is larger than the threshold value, base station 100 may set the number of bits of the RV to one bit.

For example, when the maximum number of PDSCHs that can be scheduled by one PDCCH is eight and the number of PDSCHs actually used for scheduling for terminal 200 is five, the number of bits not used in the NDI field is three bits. Thus, by using the three bits not used in the NDI field for the RV field, the total number of bits available for the RV becomes eleven bits. Accordingly, the number of bits of the RV for each of the five PDSCHs can be set to two bits. In this case, the sum of the number of bits of the RV in the PDCCH is 5 RVs×2 bits=10 bits. That is, the number of unused bits (e.g., the number of wasted bits) reserved for NDI and RV fields in the PDCCH can be reduced by increasing the number of bits of the RV for each of the five PDSCHs.

According to Method 1, by using a bit not used in an RV or NDI field without exceeding the number of bits reserved for the RV field determined according to the maximum number of PDSCHs, a two-bit RV can be used when the two-bit RV is available. The use of the two-bit RV (e.g., the use of four RVs) can improve redundancy of retransmission data and improve retransmission performance compared to the use of a one-bit RV (e.g., the use of two RVs).

### <Method 2>

In Method 2, base station 100 sets the number of bits in some RV fields to two bits even when the number of PDSCHs scheduled by one PDCCH is larger than half the maximum number of PDSCHs. For example, when the number of PDSCHs scheduled by one PDCCH is larger than half the maximum number of PDSCHs, the PDCCH may include a two-bit RV and a one-bit RV.

In other words, among RVs corresponding to the respective PDSCHs scheduled by one PDCCH, base station 100 may set the numbers of bits of some RVs to the first number of bits and set the numbers of bits of the remaining RVs to the second number of bits, which is smaller than the first number of bits.

For example, the number of RVs set to two bits may be calculated as (N mod M). The N herein represents the largest number of PDSCHs, and the M represents the number of scheduled PDSCHs.

Further, the two-bit RV may be mapped before or after the one-bit RV.

For example, when the maximum number of PDCHs that can be scheduled by one PDCCH is eight and the number of PDSCHs used for scheduling for terminal 200 is six, two RVs among six RVs for respective six PDSCHs may be set to two bits and the remaining four RVs may be set to one bit.

Alternatively, base station 100 may determine the number of bits of the RV, taking into consideration of an unused field (bit) of an NDI field (or a field different from the NDI), for example.

For example, when the maximum number of PDSCHs that can be scheduled by one PDCCH is eight and the number of PDSCHs actually used for scheduling for terminal 200 is six, the number of bits not used in the NDI field is two bits. Thus, by using two bits not used in the NDI field for the RV field, the total number of bits available for the RV becomes ten bits. Therefore, among RVs for the respective six PDSCHs, (10 mod 6)=4 RVs can be set to two bits. That is, among the six RVs, four RVs may be configured to be two-bit RVs, and the remaining two RVs may be configured to be one-bit RVs.

According to Method 2, by using a bit not used in an RV or NDI field without exceeding the number of bits reserved for the RV field determined according to the maximum number of PDSCHs, a two-bit RV can be used when the two-bit RV is available. The use of the two-bit RV (e.g., the use of four RVs) can improve redundancy of retransmission data and improve retransmission performance compared to the use of a one-bit RV (e.g., the use of two RVs).

Methods 1 and 2 according to the present embodiment have been described above.

As described above, in the present embodiment, base station 100 and terminal 200 may change a configuration of a PDCCH (or DCI) field based on the number of a plurality of PDSCHs that can be scheduled by one PDCCH (or DCI) and the number of PDSCHs assigned for terminal 200 among the plurality of PDSCHs. For example, base station 100 and terminal 200 may switch the number of bits of an RV depending on the size of the field (e.g., field to be used) that is based on the number of PDSCHs assigned for terminal 200 in the NDI or RV field configured based on the number of the plurality of PDSCHs that can be scheduled by the PDCCH.

Thus, for example, when the maximum number of PDSCHs in Multiple PDSCH scheduling is not assigned for terminal 200, an unused field of the NDI and RV fields reserved in the Multiple PDSCH scheduling can be used by being read as an RV field. Accordingly, the bits used for indication of the NDI and RV can be effectively used, which improves the use efficiency of control information.

Therefore, according to the present embodiment, the efficiency of indication of resource allocation can be enhanced.

Note that these methods are not limited to the case where PDSCHs are scheduled by dividing the schedule with a plurality of PDCCHs. For example, the above-described methods may be applied to a case where PDSCHs are not scheduled by dividing the schedule with a plurality of PDCCHs, for example, a case where HARQ-ACKs for a plurality of PDSCHs in Multiple PDSCH scheduling is transmitted by one PUCCH.

When the maximum number of PDSCHs that can be scheduled by one PDCCH is eight and the number of PDSCHs used for scheduling for terminal 200 is four, the methods can be applied because, similarly to the case where PDSCHs are scheduled by dividing the schedule with a plurality of PDCCHs, there are four unused bits in each of the NDI and RV fields. Thus, by applying methods described in the present embodiment when the number of PDSCHs actually used for scheduling for terminal 200 is smaller than the maximum number of PDSCHs that can be scheduled by one PDCCH, the number of bits of an RV for each PDSCH can be increased, and retransmission performance for each PDSCH can be enhanced, so that a delay by retransmission due to reduced number of retransmissions can be improved and throughput can also be improved.

Embodiments of the present disclosure have been described, thus far.

### OTHER EMBODIMENTS

Note that the values of the maximum number of PDSCHs that can be scheduled for terminal 200, an k0 offset, the number of slots, the number of PDCCHs, the number of PDSCHs allocated by each PDCCH, the number of bits of an RV field, frequency (e.g., 52.6 GHz to 71 GHz), and SCS used in each of the above embodiments are merely examples and not limited to the above-described values. For example, the maximum number of PDSCHs is not limited to eight and may be smaller or larger than eight. Further, the number of PDCCHs used in Multiple PDSCH scheduling is not limited to two, and may be three or more.

Although the TDRA table has been described, the information on the time-domain resource allocation is not limited to the information in a table format, and may be another type of information as long as the information is related to the association between the indexes and the information on the time-domain resource, for example.

Further, for example, the TDRA table may include k0, SLIV and another parameter of Mapping type and need not include some of the parameters illustrated in FIG. 3. Further, in the TDRA table, the SLIV may be represented by S (start symbol) and L (symbol length).

Further, configurations of information on an offset for k0 (k0 offset indicator) and an RV in a PDCCH have been described as examples in the above-described embodiments, but the parameter to be configured in the PDCCH is not limited to the k0 and RV. For example, an embodiment of the present disclosure may be applied to k1 (e.g., slot difference between a slot in which a PDSCH is mapped and a slot in which a PUCCH is mapped) or k2 (e.g., slot difference between a slot in which a PDCCH is mapped and a slot in which a PUSCH scheduled by the PDCCH is mapped) instead of k0.

### (Supplement)

Information indicating whether terminal 200 supports the functions, operations, or processes described in the above-described embodiments may be transmitted (or indicated) from terminal 200 to base station 100 as capability information or a capability parameter of terminal 200.

The capability information may include an information element (IE) individually indicating whether terminal 200 supports at least one of the functions, operations, or processes described in the above-described embodiments. Alternatively, the capability information may include an information element indicating whether terminal 200 supports a combination of any two or more of the functions, operations, and processing described in the above embodiment.

Base station 100 may determine (or assume) the function, operation, or process supported (or not supported) by terminal 200 of the transmission source of the capability information, based on the capability information received from terminal 200, for example. Base station 100 may perform an operation, processing, or control corresponding to a determination result based on the capability information. For example, base station 100 may control allocation (e.g., Multiple PDSCH scheduling) of at least one of a downlink resource such as a PDCCH or PDSCH and an uplink resource such as a PUCCH or PUSCH based on the capability information received from terminal 200.

Note that the fact that terminal 200 does not support some of the functions, operations, or processes described in the above-described embodiments may be read as that some of the functions, operations, or processes are limited in terminal 200. For example, information or a request on such limitation may be indicated to base station 100.

Information on the capability or limitation of terminal 200 may be defined, for example, in the standard, or may be implicitly indicated to base station 100 in association with information known to base station 100 or information transmitted to base station 100.

### (Control Signals)

In the present disclosure, the downlink control signal (or downlink control information) related to an embodiment of the present disclosure may be, for example, a signal (or information) transmitted through a physical downlink control channel (PDCCH) of the physical layer or may be a signal (or information) transmitted in the medium access control control element (MAC CE) of the higher layer or the radio resource control (RRC). Further, the signal (or information) is not necessarily indicated by the downlink control signal, but may be predefined in a specification (or standard) or may be preconfigured for the base station and the terminal.

In the present disclosure, the uplink control signal (or uplink control information) related to an embodiment of the present disclosure may be, for example, a signal (or information) transmitted through a PUCCH of the physical layer or may be a signal (or information) transmitted in the MAC CE of the higher layer or the RRC. Further, the signal (or information) is not necessarily indicated by the uplink control signal, but may be predefined in a specification (or standard) or may be preconfigured for the base station and the terminal. Further, the uplink control signal may be replaced with, for example, uplink control information (UCI), the 1st stage sidelink control information (SCI) or the 2nd stage SCI.

### (Base Station)

In an exemplary embodiment of the present disclosure, the base station may be a transmission reception point (TRP), a clusterhead, an access point, a remote radio head (RRH), an eNodeB (eNB), a gNodeB (gNB), a base station (BS), a base transceiver station (BTS), a base unit or a gateway, for example. Further, in the side link communication, the terminal may play a role of a base station. Furthermore, instead of the base station, a relay apparatus that relays communication between a higher node and a terminal may be used. Moreover, a road side device may be used.

### (Uplink/Downlink/Sidelink)

An exemplary embodiment of the present disclosure may be applied to, for example, any of uplink, downlink, and sidelink. An exemplary embodiment of the present disclosure may be applied to, for example, uplink channels, such as physical uplink shared channel (PUSCH), physical uplink control channel (PUCCH), and physical random access channel (PRACH), downlink channels, such as physical downlink shared channel (PDSCH), PDCCH, and physical broadcast channel (PBCH), or sidelink channels, such as physical sidelink shared channel (PSSCH), physical sidelink control channel (PSCCH), and physical sidelink broadcast channel (PSBCH).

Note that, PDCCH, PDSCH, PUSCH, and PUCCH are examples of a downlink control channel, a downlink data channel, an uplink data channel, and an uplink control channel, respectively. Further, PSCCH and PSSCH are examples of a side link control channel and a sidelink data channel, respectively. Further, PBCH and PSBCH are examples of broadcast channels, and PRACH is an example of a random access channel.

### (Data Channel/Control Channel)

An exemplary embodiment of the present disclosure may be applied to, for example, any of the data channels and control channels. For example, the channel in an exemplary embodiment of the present disclosure may be replaced with one of data channels including PDSCH, PUSCH and PSSCH or control channels including PDCCH, PUCCH, PBCH, PSCCH, and PSBCH.

### (Reference Signals)

In an exemplary embodiment of the present disclosure, the reference signals are, for example, signals known to both a base station and a mobile station and each reference signal may be referred to as a reference signal (RS) or sometimes a pilot signal. The reference signal may be any of a demodulation reference signal (DMRS), a channel state information-reference signal (CSI-RS), a tracking reference signal (TRS), a phase tracking reference signal (PTRS), a cell-specific reference signal (CRS), or a sounding reference signal (SRS).

### (Time Intervals)

In an exemplary embodiment of the present disclosure, time resource units are not limited to one or a combination of slots and symbols, and may be time resource units, such as frames, superframes, subframes, slots, time slots, subslots, minislots, or time resource units, such as symbols, orthogonal frequency division multiplexing (OFDM) symbols, single carrier-frequency division multiplexing (SC-FDMA) symbols, or other time resource units. The number of symbols included in one slot is not limited to any number of symbols exemplified in the embodiments described above, and may be other numbers of symbols.

### (Frequency Bands)

An exemplary embodiment of the present disclosure may be applied to any of a licensed band and an unlicensed band.

### (Communication)

An exemplary embodiment of the present disclosure may be applied to any of communication between a base station and a terminal (Uu-link communication), communication between a terminal and a terminal (sidelink communication), and vehicle to everything (V2X) communication. The channels in an exemplary embodiment of the present disclosure may be replaced with any of a PSCCH, a PSSCH, a physical sidelink feedback channel (PSFCH), a PSBCH, a PDCCH, a PUCCH, a PDSCH, a PUSCH, and a PBCH.

Further, an exemplary embodiment of the present disclosure may be applied to any of a terrestrial network or a network other than a terrestrial network (NTN: non-terrestrial network) using a satellite or a high altitude pseudo satellite (HAPS). In addition, an exemplary embodiment of the present disclosure may be applied to a network having a large cell size, and a terrestrial network with a large delay compared with a symbol length or a slot length, such as an ultra-wideband transmission network.

### (Antenna Ports)

In an exemplary embodiment of the present disclosure, an antenna port refers to a logical antenna (antenna group) formed of one or more physical antenna(s). For example, the antenna port does not necessarily refer to one physical antenna and sometimes refers to an array antenna formed of multiple antennas or the like. For example, it is not defined how many physical antennas form the antenna port, and instead, the antenna port is defined as the minimum unit through which a terminal station is allowed to transmit a reference signal. The antenna port may also be defined as the minimum unit for multiplication of a precoding vector weighting.

### <5G NR System Architecture and Protocol Stacks>

3GPP has been working at the next release for the 5th generation cellular technology, simply called 5G, including the development of a new radio (NR) access technology operating in frequencies ranging up to 100 GHz. The first version of 5G standard was initially delivered in late 2017, which allows proceeding to trials and commercial deployments of 5G NR standard-compliant terminals, e.g., smartphones.

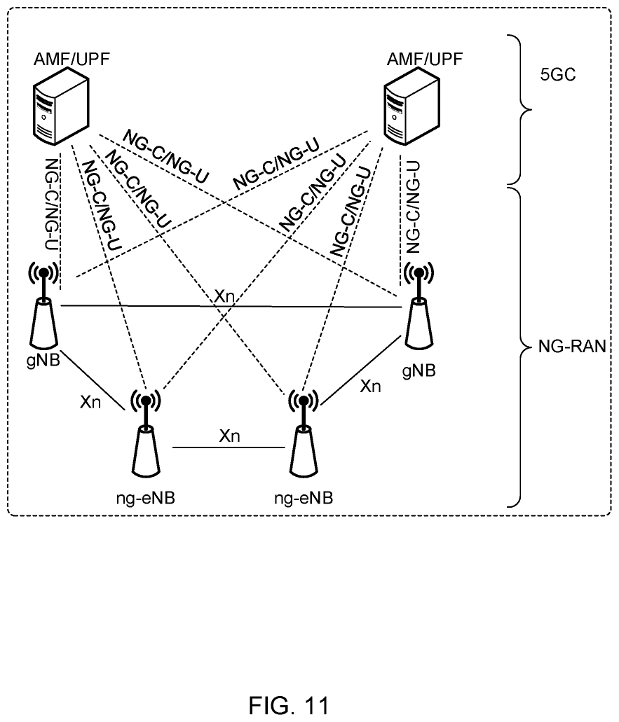

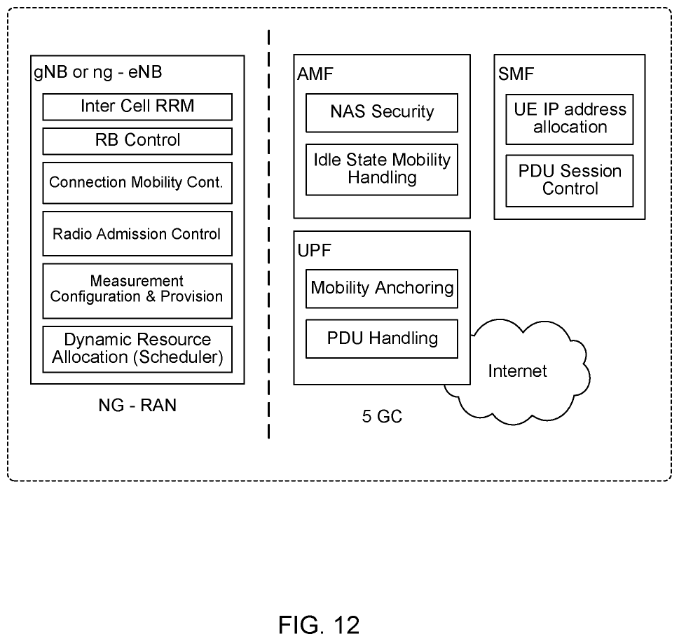

For example, the overall system architecture assumes a Next Generation-Radio Access Network (NG-RAN) that includes gNBs. The gNBs provide the NG-radio access user plane (SDAP/PDCP/RLC/MAC/PHY) and control plane (RRC) protocol terminations towards a UE. The gNBs are interconnected with each other via an Xn interface. The gNBs are also connected to the Next Generation Core (NGC) via the Next Generation (NG) interface, more specifically to the Access and Mobility Management Function (AMF; e.g. a particular core entity performing the AMF) via the NG-C interface, and to the User Plane Function (UPF; e.g., a particular core entity performing the UPF) via the NG-U interface. The NG-RAN architecture is illustrated in FIG. 11 (see, e.g., 3GPP TS 38.300 v15.6.0, section 4).

The user plane protocol stack for NR (see, e.g., 3GPP TS 38.300, section 4.4.1) includes the Packet Data Convergence Protocol (PDCP, see clause 6.4 of TS 38.300) Radio Link Control (RLC, see clause 6.3 of TS 38.300) and Medium Access Control (MAC, see clause 6.2 of TS 38.300) sublayers, which are terminated in the gNB on the network side. Additionally, a new access stratum (AS) sublayer (Service Data Adaptation Protocol: SDAP) is introduced above the PDCP (see, e.g., clause 6.5 of 3GPP TS 38.300). A control plane protocol stack is also defined for NR (see, e.g., TS 38.300, section 4.4.2). An overview of the Layer 2 functions is given in clause 6 of TS 38.300. The functions of the PDCP, RLC, and MAC sublayers are listed respectively in clauses 6.4, 6.3, and 6.2 of TS 38.300. The functions of the RRC layer are listed in clause 7 of TS 38.300.

For example, the Medium-Access-Control layer handles logical-channel multiplexing, and scheduling and scheduling-related functions, including handling of different numerologies.

The physical layer (PHY) is, for example, responsible for coding, PHY HARQ processing, modulation, multi-antenna processing, and mapping of the signal to the appropriate physical time-frequency resources. The physical layer also handles mapping of transport channels to physical channels. The physical layer provides services to the MAC layer in the form of transport channels. A physical channel corresponds to the set of time-frequency resources used for transmission of a particular transport channel, and each transport channel is mapped to a corresponding physical channel. For example, the physical channels include a Physical Random Access Channel (PRACH), Physical Uplink Shared Channel (PUSCH), and Physical Uplink Control Channel (PUCCH) as uplink physical channels, and a Physical Downlink Shared Channel (PDSCH), Physical Downlink Control Channel (PDCCH), and Physical Broadcast Channel (PBCH) as downlink physical channels.

Use cases/deployment scenarios for NR could include enhanced mobile broadband (eMBB), ultra-reliable low-latency communications (URLLC), massive machine type communication (mMTC), which have diverse requirements in terms of data rates, latency, and coverage. For example, the eMBB is expected to support peak data rates (20 Gbps for downlink and 10 Gbps for uplink) and user-experienced data rates in the order of three times what is offered by IMT-Advanced. Meanwhile, in a case of the URLLC, the tighter requirements are put on ultra-low latency (0.5 ms for each of UL and DL for user plane latency) and high reliability (1-10-5 within 1 ms). Finally, the mMTC may preferably require high connection density (1,000,000 devices/km2 in an urban environment), large coverage in harsh environments, and extremely long-life battery for low cost devices (15 years).

Thus, the OFDM numerology (e.g., subcarrier spacing, OFDM symbol duration, cyclic prefix (CP) duration, the number of symbols per scheduling interval) that is suitable for one use case might not work well for another. For example, low-latency services may preferably require a shorter symbol duration (and thus larger subcarrier spacing) and/or fewer symbols per scheduling interval (also referred to as TTI) than an mMTC service. Furthermore, deployment scenarios with large channel delay spreads may preferably require a longer CP duration than scenarios with short delay spreads. The subcarrier spacing may be optimized accordingly to retain the similar CP overhead. NR may support more than one value of subcarrier spacing. Correspondingly, subcarrier spacing of 15 kHz, 30 kHz, 60 kHz . . . are currently considered. The symbol duration Tu and the subcarrier spacing Δf are directly related through the formula Δf=1/Tu. In a similar manner as in LTE systems, the term “resource element” can be used to denote a minimum resource unit being composed of one subcarrier for the length of one OFDM/SC-FDMA symbol.

In the new radio system 5G-NR, for each numerology and carrier, a resource grid of subcarriers and OFDM symbols is defined for each of uplink and downlink. Each element in the resource grid is called a resource element and is identified based on the frequency index in the frequency domain and the symbol position in the time domain (see 3GPP TS 38.211 v15.6.0).

### <5G NR Functional Split Between NG-RAN and 5GC>

FIG. 12 illustrates functional split between NG-RAN and 5GC. An NG-RAN logical node is a gNB or ng-eNB. The 5GC has logical nodes AMF, UPF, and SMF.

For example, the gNB and ng-eNB host the following main functions:
Functions for radio resource management such as radio bearer control, radio admission control, connection mobility control, dynamic allocation of resources to UEs in both uplink and downlink (scheduling);
IP header compression, encryption, and integrity protection of data;
Selection of an AMF at UE attachment when no routing to an AMF can be determined from the information provided by the UE;
Routing of user plane data towards UPF(s);
Routing of control plane information towards AMF;
Connection setup and release;
Scheduling and transmission of paging messages;
Scheduling and transmission of system broadcast information (originated from the AMF or Operation, Admission, Maintenance (OAM));
Measurement and measurement reporting configuration for mobility and scheduling;
Transport level packet marking in the uplink;
Session management;
Support of network slicing;
QoS Flow management and mapping to data radio bearers;
Support of UEs in RRC_INACTIVE state;
Distribution function for NAS messages;
Radio access network sharing;
Dual Connectivity; and
Tight interworking between NR and E-UTRA.

The access and mobility management function (AMF) hosts the following main functions:
Non-Access Stratum (NAS) signaling termination function;
NAS signaling security;
Access Stratum (AS) security control;
Inter Core Network (CN) node signaling for mobility between 3GPP access networks;
Idle mode UE reachability (including control and execution of paging retransmission);
Registration area management;
Support of intra-system and inter-system mobility;
Access authentication;
Access authorization including check of roaming rights;
Mobility management control (subscription and policies);
Support of network slicing; and
Session Management Function (SMF) selection.

Furthermore, the user plane function (UPF) hosts the following main functions:
Anchor point for intra-/inter-RAT mobility (when applicable);
External protocol data unit (PDU) session point of interconnect to a data network;
Packet routing and forwarding;
Packet inspection and user plane part of policy rule enforcement;
Traffic usage reporting;
Uplink classifier to support routing traffic flows to a data network;
Branching point to support multi-homed PDU session;
QoS handling for user plane (e.g. packet filtering, gating, and UL/DL rate enforcement);
Uplink traffic verification (SDF to QoS flow mapping); and
Downlink packet buffering and downlink data indication triggering.

Finally, the session management function (SMF) hosts the following main functions:
Session management;
UE IP address allocation and management;
Selection and control of UPF;
Configuration function of traffic steering at a user plane function (UPF) to route traffic to proper destination;
Control part of policy enforcement and QoS; and
Downlink data indication

### <RRC Connection Setup and Reconfiguration Procedures>

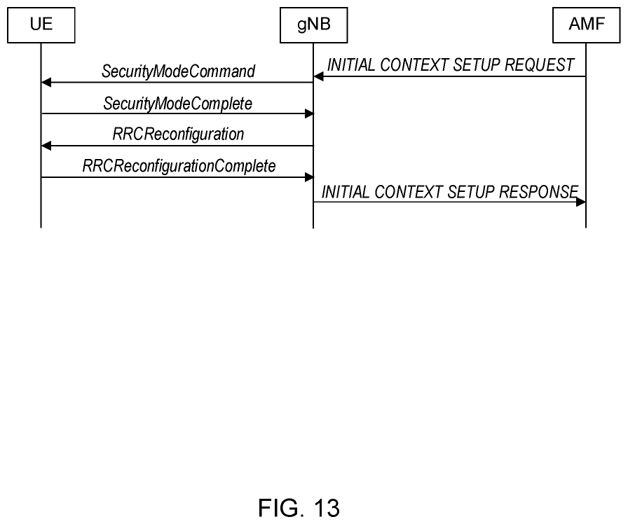

FIG. 13 illustrates some interactions between a UE, gNB, and AMF (an 5GC entity) in the context of a transition of the UE from RRC_IDLE to RRC CONNECTED for the NAS part (see TS 38.300 v15.6.0).

RRC is a higher layer signaling (protocol) used for UE and gNB configuration. This transition involves that the AMF prepares the UE context data (including, for example, PDU session context, security key, UE radio capability, and UE security capabilities, etc.) and transmits the UE context data to the gNB with an INITIAL CONTEXT SETUP REQUEST. Then, the gNB activates the AS security with the UE, which is performed by the gNB transmitting a SecurityModeCommand message to the UE and by the UE responding to the gNB with a SecurityModeComplete message. Afterwards, the gNB performs the reconfiguration to set up the Signaling Radio Bearer 2 (SRB2) and Data Radio Bearer(s) (DRB(s)) by transmitting an RRCReconfiguration message to the UE and, in response, receiving an RRCReconfigurationComplete from the UE. For a signaling-only connection, the steps relating to the RRCReconfiguration are skipped since the SRB2 and DRBs are not setup. Finally, the gNB indicates to the AMF that the setup procedure is completed with an INITIAL CONTEXT SETUP RESPONSE.

In the present disclosure, thus, an entity (e.g., AMF, SMF, etc.) of the 5th Generation Core (5GC) is provided that includes control circuitry, which, in operation, establishes a Next Generation (NG) connection with a gNodeB, and a transmitter, which in operation, transmits an initial context setup message, via the NG connection, to the gNodeB to cause a signaling radio bearer setup between the gNodeB and user equipment (UE). In particular, the gNodeB transmits a radio resource control (RRC) signaling containing a resource allocation configuration information element (IE) to the UE via the signaling radio bearer. The UE then performs an uplink transmission or a downlink reception based on the resource allocation configuration.

### <Usage Scenarios of IMT for 2020 and Beyond>

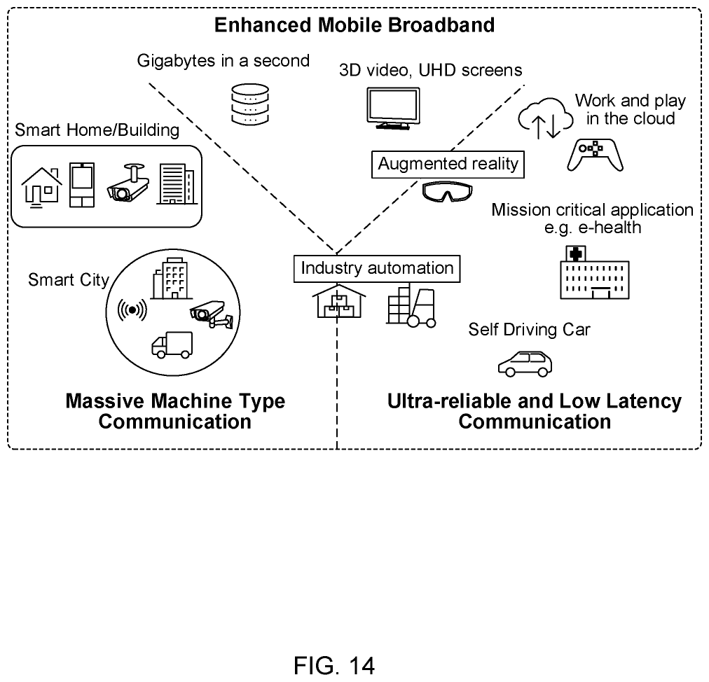

FIG. 14 illustrates some of the use cases for 5G NR. In the 3rd generation partnership project new radio (3GPP NR), three use cases are being considered that have been envisaged to support a wide variety of services and applications by IMT-2020. The specification for the phase 1 of enhanced mobile-broadband (eMBB) has been concluded. In addition to further extending the eMBB support, the current and future work would involve the standardization for ultra-reliable and low-latency communications (URLLC) and massive machine-type communications (mMTC). FIG. 14 illustrates some examples of envisioned usage scenarios for IMT for 2020 and beyond (see, e.g., ITU-R M. 2083 FIG. 2).

The URLLC use case has stringent requirements for capabilities such as throughput, latency, and availability. The URLLC use case has been envisioned as one of element techniques to enable future vertical applications such as wireless control of industrial manufacturing or production processes, remote medical surgery, distribution automation in a smart grid, transportation safety, etc. Ultra-reliability for the URLLC is to be supported by identifying the techniques to meet the requirements set by TR 38.913. For NR URLLC in Release 15, key requirements include a target user plane latency of 0.5 ms for uplink (UL) and 0.5 ms for downlink (DL). The general URLLC requirement for one transmission of a packet is a block error rate (BLER) of 1E-5 for a packet size of 32 bytes with a user plane latency of 1 ms.

From the physical layer perspective, reliability can be improved in a number of possible ways. The current scope for improving the reliability involves defining separate CQI tables for the URLLC, more compact DCI formats, repetition of PDCCH, etc. However, the scope may widen for achieving ultra-reliability as the NR becomes more stable and developed (for NR URLLC key requirements). Particular use cases of NR URLLC in Release 15 include augmented reality/virtual reality (AR/VR), e-health, e-safety, and mission-critical applications.

Moreover, technology enhancements targeted by NR URLLC aim at latency improvement and reliability improvement. Technology enhancements for latency improvement include configurable numerology, non slot-based scheduling with flexible mapping, grant free (configured grant) uplink, slot-level repetition for data channels, and downlink pre-emption. The pre-emption means that a transmission for which resources have already been allocated is stopped, and the already allocated resources are used for another transmission that has been requested later but has lower latency/higher priority requirements. Accordingly, the already granted transmission is replaced with a later transmission. The pre-emption is applicable independent of the particular service type. For example, a transmission for a service-type A (URLLC) may be replaced with a transmission for a service type B (such as eMBB). Technology enhancements with respect to reliability improvement include dedicated CQI/MCS tables for the target BLER of 1E-5.

The use case of the mMTC (massive machine type communication) is characterized by a very large number of connected devices typically transmitting a relatively low volume of non-delay sensitive data. Devices are required to be low cost and to have a very long battery life. From the NR perspective, utilizing very narrow bandwidth parts is one possible solution to have power saving from the UE perspective and enable the long battery life.

As mentioned above, it is expected that the scope of reliability improvement in NR becomes wider. One key requirement to all the cases, and especially necessary for the URLLC and mMTC for example, is high reliability or ultra-reliability. Several mechanisms can be considered to improve the reliability from the radio perspective and network perspective. In general, there are a few key important areas that can help improve the reliability. These areas include compact control channel information, data/control channel repetition, and diversity with respect to the frequency, time, and/or spatial domain. These areas are applicable to reliability improvement in general, regardless of particular communication scenarios.

For NR URLLC, further use cases with tighter requirements have been considered such as factory automation, transport industry, and electrical power distribution. The tighter requirements are higher reliability (up to 10-6 level), higher availability, packet size of up to 256 bytes, time synchronization down to the order of a few us where the value can be one or a few us depending on frequency range and short latency in the order of 0.5 to 1 ms (e.g., target user plane latency of 0.5 ms) depending on the use cases.

Moreover, for NR URLLC, several technology enhancements from the physical layer perspective have been identified. These technology enhancements include Physical Downlink Control Channel (PDCCH) enhancements related to compact DCI, PDCCH repetition, and increased PDCCH monitoring. In addition, Uplink Control Information (UCI) enhancements are related to enhanced Hybrid Automatic Repeat Request (HARQ) and CSI feedback enhancements. Also, PUSCH enhancements related to mini-slot level hopping and retransmission/repetition enhancements have been identified. The term “mini-slot” refers to a transmission time interval (TTI) including a smaller number of symbols than a slot (a slot includes fourteen symbols).

### <QoS Control>

The 5G Quality of Service (QOS) model is based on QoS flows and supports both QoS flows that require guaranteed flow bit rate (GBR QoS flows) and QoS flows that do not require guaranteed flow bit rate (non-GBR QOS Flows). At the NAS level, the QoS flow is thus the finest granularity of QOS differentiation in a PDU session. A QoS flow is identified within a PDU session by a QoS flow ID (QFI) carried in an encapsulation header over the NG-U interface.

For each UE, the 5GC establishes one or more PDU sessions. For each UE, the NG-RAN establishes at least one Data Radio Bearer (DRB) together with the PDU session, for example as illustrated above with reference to FIG. 13. Additional DRB(s) for QoS flow(s) of that PDU session can be subsequently configured (it is up to NG-RAN when to do so). The NG-RAN maps packets belonging to different PDU sessions to different DRBs. NAS level packet filters in the UE and 5GC associate UL and DL packets with QoS flows, whereas AS-level mapping rules in the UE and in the NG-RAN associate UL and DL QoS flows with DRBs.

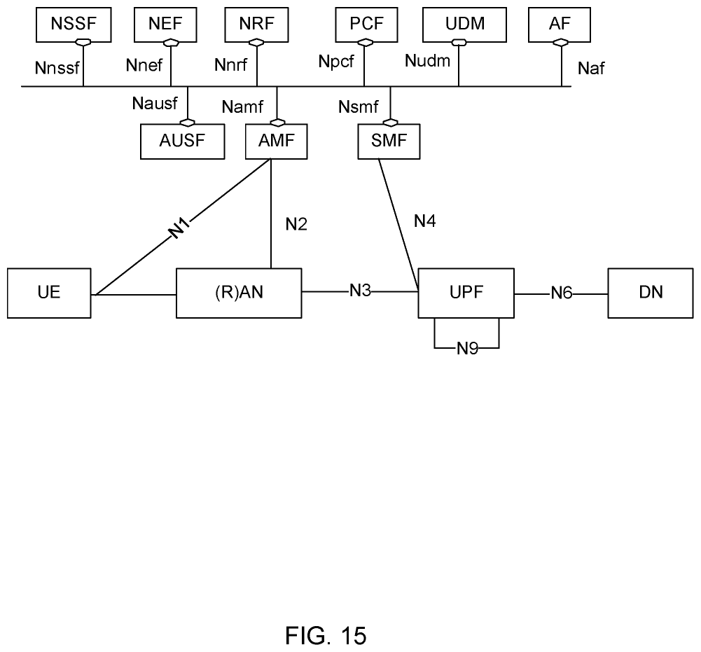

FIG. 15 illustrates a 5G NR non-roaming reference architecture (see TS 23.501 v16.1.0, section 4.23). An Application Function (AF), for example, an external application server hosting 5G services exemplified in FIG. 14, interacts with the 3GPP core network in order to provide services, for example, to support application influence on traffic routing, accessing a Network Exposure Function (NEF) or interacting with the policy framework for policy control (see Policy Control Function, PCF), for example, QoS control. Based on operator deployment, application functions considered to be trusted by the operator can be allowed to interact directly with relevant network functions. Application functions not allowed by the operator to access directly the network functions use the external exposure framework via the NEF to interact with relevant network functions.

FIG. 15 illustrates further functional units of the 5G architecture, namely a Network Slice Selection Function (NSSF), Network Repository Function (NRF), Unified Data Management (UDM), Authentication Server Function (AUSF), Access and Mobility Management Function (AMF), Session Management Function (SMF), and Data Network (DN), for example, operator services, Internet access, or 3rd party services. All of or a part of the core network functions and the application services may be deployed and running on cloud computing environments.

In the present disclosure, thus, an application server (e.g., AF of the 5G architecture), is provided that includes a transmitter, which in operation, transmits a request containing a QoS requirement for at least one of the URLLC, eMMB, and mMTC services to at least one of functions (e.g., NEF, AMF, SMF, PCF, UPF, etc) of the 5GC to establish a PDU session including a radio bearer between a gNodeB and a UE in accordance with the QoS requirement, and control circuitry, which, in operation, performs the services using the established PDU session.

The present disclosure can be realized by software, hardware, or software in cooperation with hardware. Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, an FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. The communication apparatus may comprise a transceiver and processing/control circuitry. The transceiver may comprise and/or function as a receiver and a transmitter. The transceiver, as the transmitter and receiver, may include an RF (radio frequency) module including amplifiers, RF modulators/demodulators and the like, and one or more antennas. Some non-limiting examples of such a communication apparatus include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT).”

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

A base station according to an embodiment of the present disclosure includes: control circuitry, which, in operation, changes a configuration of a field of a control signal depending on a size of a certain field used for assignment for a terminal in a first field of the control signal, the certain field being referred to as a second field; and transmission circuitry, which, in operation, transmits the control signal based on the configuration.

In the embodiment of the present disclosure, a size of the first field is based on a first number of a plurality of data channels schedulable by a single control signal which is the control signal, and the size of the second field is based on a second number of data channels assigned for the terminal among the plurality of data channels.

In the embodiment of the present disclosure, the control circuitry determines configuration of information on an offset for a difference between a slot in which the control signal is mapped and a slot in which at least one of the data channels assigned by the control signal is mapped, when the second number is smaller than a threshold value, the information being configured in the field of the control signal, and determines non-configuration of the information on the offset in the field of the control signal when the second number is equal to or larger than the threshold value.

In the embodiment of the present disclosure, the information on the offset indicates whether to apply the offset.

In the embodiment of the present disclosure, the information on the offset includes information identifying any one of a plurality of candidates for the offset.

In the embodiment of the present disclosure, the control circuitry configures the information on the offset in a field different from the second field corresponding to the second number in the first field corresponding to the first number for at least one of a new data indicator (NDI) and/or a redundancy version (RV).

In the embodiment of the present disclosure, the control circuitry changes the number of bits of a redundancy version (RV) corresponding to each of the second number of the data channels, depending on the second number.

In the embodiment of the present disclosure, the control circuitry configures the number of bits corresponding to each of the second number of the data channels as a first number of bits when the second number is equal to or smaller than a threshold value, and configures the number of bits corresponding to each of the second number of the data channels as a second number of bits that is smaller than the first number of bits when the second number is larger than the threshold value.

In the embodiment of the present disclosure, the control circuitry configures the number of bits of some of a plurality of the RVs respectively corresponding to the second number of the data channels as a first number of bits, and configures the number of bits of the remaining RVs as a second number of bits that is smaller than the first number of bits.

In the embodiment of the present disclosure, the control circuitry configures a field of the RV using a field of a new data indicator (NDI).

In the embodiment of the present disclosure, a size of the first field is based on a number of a plurality of transport blocks in one data channel schedulable by a single control signal which is the one control signal, and the size of the second field is based on a number of transport blocks assigned for the terminal among the plurality of transport blocks.

A terminal according to an embodiment of the present disclosure includes: control circuitry, which, in operation, changes a configuration of a field of a control signal depending on a size of a certain field used for assignment for a terminal in a first field of the control signal, the certain field being referred to as a second field; and reception circuitry, which, in operation, receives the control signal based on the configuration.

In a communication method according to an embodiment of the present disclosure, a base station changes a configuration of a field of a control signal depending on a size of a certain field used for assignment for a terminal in a first field of the control signal, the certain field being referred to as a second field, and transmits the control signal based on the configuration.

In a communication method according to an embodiment of the present disclosure, a terminal changes a configuration of a field of a control signal depending on a size of a certain field used for assignment for a terminal in a first field of the control signal, the certain field being referred to as a second field, and receives the control signal based on the configuration.

The disclosure of Japanese Patent Application No. 2021-129181, filed on Aug. 5, 2021, including the specification, drawings and abstract, is incorporated herein by reference in its entirety.

### INDUSTRIAL APPLICABILITY

An exemplary embodiment of the present disclosure is useful for mobile communication systems.

### REFERENCE SIGNS LIST

100 Base station
101, 201 Receiver
102 Demodulator/decoder
103 Scheduler
104, 206 Control information holder
105 Control information generator
106 Data generator
107, 208 Encoder/modulator
108, 209 Transmitter
200 Terminal
202 Control information demodulator/decoder
203 Data demodulator/decoder
204 Determiner
205 Transmission controller
207 Data/control information generator

1. A base station, comprising:
control circuitry, which, in operation, changes a configuration of a field of a control signal depending on a size of a certain field used for assignment for a terminal in a first field of the control signal, the certain field being referred to as a second field; and
transmission circuitry, which, in operation, transmits the control signal based on the configuration.

2. The base station according to claim 1, wherein
a size of the first field is based on a first number of a plurality of data channels schedulable by a single control signal which is the control signal, and the size of the second field is based on a second number of data channels assigned for the terminal among the plurality of data channels.

3. The base station according to claim 2, wherein
the control circuitry determines configuration of information on an offset for a difference between a slot in which the control signal is mapped and a slot in which at least one of the data channels assigned by the control signal is mapped, when the second number is smaller than a threshold value, the information being configured in the field of the control signal, and determines non-configuration of the information on the offset in the field of the control signal when the second number is equal to or larger than the threshold value.

4. The base station according to claim 3, wherein
the information on the offset indicates whether to apply the offset.

5. The base station according to claim 3, wherein
the information on the offset includes information identifying any one of a plurality of candidates for the offset.

6. The base station according to claim 3, wherein
the control circuitry configures the information on the offset in a field different from the second field corresponding to the second number in the first field corresponding to the first number for at least one of a new data indicator (NDI) and/or a redundancy version (RV).

7. The base station according to claim 2, wherein
the control circuitry changes the number of bits of a redundancy version (RV) corresponding to each of the second number of the data channels, depending on the second number.

8. The base station according to claim 7, wherein
the control circuitry configures the number of bits corresponding to each of the second number of the data channels as a first number of bits when the second number is equal to or smaller than a threshold value, and configures the number of bits corresponding to each of the second number of the data channels as a second number of bits that is smaller than the first number of bits when the second number is larger than the threshold value.

9. The base station according to claim 7, wherein
the control circuitry configures the number of bits of some of a plurality of the RVs respectively corresponding to the second number of the data channels as a first number of bits, and configures the number of bits of the remaining RVs as a second number of bits that is smaller than the first number of bits.

10. The base station according to claim 7, wherein
the control circuitry configures a field of the RV using a field of a new data indicator (NDI).

11. The base station according to claim 1, wherein
a size of the first field is based on a number of a plurality of transport blocks in one data channel schedulable by a single control signal which is the control signal, and the size of the second field is based on a number of transport blocks assigned for the terminal among the plurality of transport blocks.

12. A terminal, comprising:
control circuitry, which, in operation, changes a configuration of a field of a control signal depending on a size of a certain field used for assignment for a terminal in a first field of the control signal, the certain field being referred to as a second field; and
reception circuitry, which, in operation, receives the control signal based on the configuration.

13. A communication method, comprising:
changing, by a base station, a configuration of a field of a control signal depending on a size of a certain field used for assignment for a terminal in a first field of the control signal, the certain field being referred to as a second field; and
transmitting, by the base station, the control signal based on the configuration.

14. A communication method, comprising:
changing, by a terminal, a configuration of a field of a control signal depending on a size of a certain field used for assignment for a terminal in a first field of the control signal, the certain field being referred to as a second field; and
receiving, by the terminal, the control signal based on the configuration.
